(19) United States
(12) Patent Application Publication
(10) Pub. No.: US 2007/0104985 A1
(43) Pub. Date: May 10, 2007

(54) FEEDBACK FUEL CELL DEVICE

(76) Inventor: Chun-Chin Tung, Chupei (TW)

Correspondence Address: G. LINK CO., LTD., 3550 BELL ROAD, MINOOKA, IL, 60447, US

(21) Appl. No.: 11/557,800

(22) Filed: Nov. 8, 2006

(30) Foreign Application Priority Data
Nov. 9, 2005 (TW) 094139292

(51) Int. Cl. H01M 8/04; H01M 8/10

(52) U.S. Cl. 429/23; 429/32

(57) ABSTRACT

The present invention relates to a feedback fuel cell device consisting of: a fuel cell, a circuit mechanism and a logic processor. The fuel cell is electrically connected to the circuit mechanism that contains an electric power integration mechanism and circuit for detecting an open-circuit voltage. In the circuit mechanism, the electric power integration mechanism is electrically connected to a first membrane electrode assembly and provides a power output, and the means for detecting the open-circuit voltage is electrically connected to a second membrane electrode assembly. The logic processor is electrically connected to the circuit mechanism and contains a temperature determination means, which determines a temperature value corresponding to the open-circuit voltage of the second membrane electrode assembly through the means for detecting the open-circuit voltage.

### FIELD OF THE INVENTION

The present invention relates to a feedback fuel cell device, and more particularly to the feedback fuel cell provided with the open-circuit voltage detection of the membrane electrode assembly in a fuel cell, whereby a temperature corresponding thereto is determinable.

### BACKGROUND OF THE INVENTION

Conventional fuel cells have cell cores using hydrogen-rich fuels, such as methanol, to conduct an electrochemical reaction with oxygen fuels so as to generate the electricity. The operation state (such as output voltage/current) of the conventional fuel cell core is performed by setting the operation conditions of the fuel cells, and the power generated by the fuel cell is output through a power-collecting grid thereof. The conditions for electric power output of the conventional fuel cell always depend on the temperature of the fuel cell, and therefore it needs to develop a temperature measuring means, which can measure the on-time temperature of the fuel cell therein, so as to monitor the power output of the fuel cell. However, the conventional temperature measuring is performed by temperature sensors such as MEMS-based temperature sensors or thermocouples, which increases the cost and complication of the manufacturing process thereof. Hence, due to the need for measuring the temperature of conventional fuel cells, the present invention is developed to provide a temperature sensor mechanism of the fuel cell to measure the on-time temperature thereof so as to further monitor the power output of the fuel cell.

### SUMMARY OF THE INVENTION

It is a first object of this invention to provide a feedback fuel cell device, in which the temperature thereof can be obtained through detecting the open-circuit voltage of the membrane electrode assembly and reading by the logic processor.

It is a further object of this invention to provide a feedback fuel cell device, in which the energy conversion mechanism and temperature sensing mechanism is achievable by the membrane electrode assemblies provided therein. Thus, the cost resulting from the use of a separate temperature-sensing device can be saved and the manufacturing process of the fuel cell device with the temperature feedback can be simplified.

To achieve the above objects, the invention provides a feedback fuel cell device comprised of: a fuel cell, a circuit mechanism and a logic processor. In the provided feedback fuel cell device, the fuel cell is electrically connected to the circuit mechanism, which includes a power integration mechanism and a means for detecting an open-circuit voltage. The power integration mechanism is electrically connected to the first membrane electrode assembly and provides a power output, whereas the means for detecting the open-circuit voltage is electrically connected to the second membrane electrode assembly in the circuit mechanism. The logic processor is also electrically connected to the circuit mechanism, and includes a temperature determination means, which determines a temperature corresponding to the open-circuit voltage of the second membrane electrode assembly through the means for detecting the open-circuit voltage.

Moreover, the circuit mechanism further includes a means for power transfer selection for selecting the second membrane electrode assembly to be electrically connected to the means for detecting the open-circuit voltage and to transfer power to the power integration mechanism at any one state thereof, and the logic processor further comprises the load selecting mechanism control device controlling the means for power transfer selection and selecting the second membrane electrode assembly to be electrically connected to the means for detecting the open-circuit voltage and to transfer power to the power integration mechanism at any one state thereof.

Furthermore, the fuel cell, the circuit mechanism and the logic processor are electrically connected in such a way that the circuit mechanism and the logic processor are located inside the fuel cell or are electrically connected and are connected to the fuel cell with an electrical interface.

The foregoing and other features and advantages of the present invention will be more clearly understood through the following descriptions with reference to the drawings, wherein:

### BRIEF DESCRIPTION OF THE DRAWINGS

FIG. 1 is a diagram schematically illustrating the components of the feedback fuel cell device in accordance with a preferred embodiment of this invention;

FIG. 2 is a diagram showing the time-voltage curve of the fuel cell in an open circuit;

FIG. 3 is a flowchart illustrating the operation of the feedback fuel cell device of this invention; and

FIG. 4 is a diagram schematically illustrating the components of the feedback fuel cell device in accordance with a further preferred embodiment of this invention.

### DETAILED DESCRIPTION OF THE INVENTION

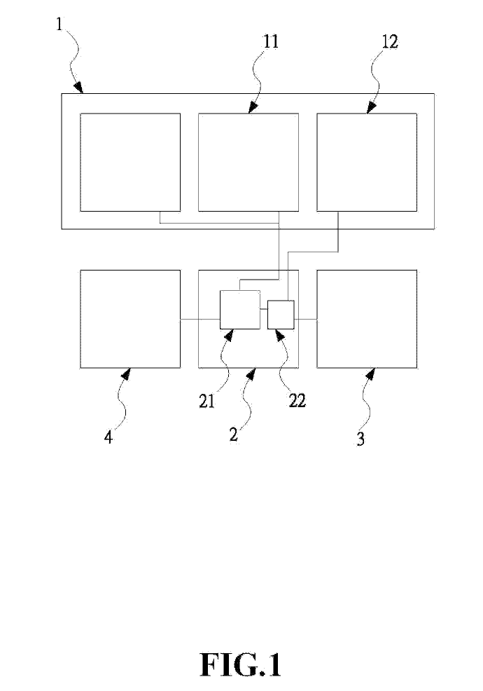

FIG. 1 is a diagram schematically illustrating the components of the feedback fuel cell device in accordance with a preferred embodiment of this invention. Referring to FIG. 1, the feedback fuel cell device of the invention comprises a fuel cell 1, which is electrically connected to a circuit mechanism 2. The circuit mechanism 2 is electrically connected to a logic processor 3 and a load 4, and feeds the power generated by the fuel cell 1 to the load 4.

In the above-mentioned feedback fuel cell device of this invention, the fuel cell 1 can be a circuit-based multilayered fuel cell, which has at least one first membrane electrode assembly 11 and one second membrane electrode assembly 12. The first membrane electrode assembly 11 and the second membrane electrode assembly 12 in the fuel cell are provided with catalysts for conducting an electrochemical reaction by combining hydrogen-rich fuels and oxygen fuels, and make the fuel cell 1 become an energy converter that converts the chemical energy into the electric energy. The circuit mechanism 2 includes a power integration mechanism 21 and a load switching mechanism 22. The power integration mechanism 21 is responsible for electric power transfer and electric power regulation, whereas the load switching mechanism 22 is responsible for the open-circuit voltage detection and the power transfer selection; hereinto, the power integration mechanism 21 is electrically connected to the first membrane electrode assembly 11, the load switching mechanism 22, and the load 4, whereas the load switching mechanism 22 is electrically connected to the second membrane electrode assembly 12 and the power integration mechanism 21. Therefore, the power integration mechanism 21 can transfer the electric power generated from the first membrane electrode assembly 11 or from the second membrane electrode assembly 12 to the load 4, and can regulate the electric power and deliver electricity at a specific voltage or current. The open-circuit voltage detection device of the load switching mechanism 22 allows an open circuit parallel to be connected to the second membrane electrode assembly 12 and measures the voltage of the second membrane electrode assembly 12 simultaneously. The power transfer selection device of the load switching mechanism 22 is performed to electrically connect the second membrane electrode assembly 12 to the open-circuit voltage detection device of the second membrane electrodes 12 to transfer the power to the power integration mechanism 21. Moreover, the logic processor 3 contains the means for load selection control and the temperature determination device, in which the means for load selection control controls the load switching mechanism 22 to select the second membrane electrode assembly 12 either to be connected to the open-circuit voltage detection device or to transfer electric power to the power integration mechanism 21. The temperature determination device in the logic processor 3 determines the temperature value corresponding to the open-circuit voltage value of the second membrane electrode assembly 12, which is measured by the open-circuit voltage detection device of the load switching mechanism 22. Moreover, the temperature determination means of the logic processor 3 also determines the temperature value corresponding to the open-circuit voltage of the second membrane electrode assembly through a function-based calculation process or an internal-built reference table.

The power integration mechanism 21 and the load switching mechanism 22 in the above-mentioned circuit mechanism 2 and the logic processor 3 can be in the form of circuits and in the form of integrated circuits, or any other equivalent devices only if they have the correspondent means of electrical control and operation.

Moreover, the above-mentioned circuit mechanism 2 and the logic professor 3 can be directly located inside the fuel cell 1 or can be electrically connected to the fuel cell 1 through an electrical interface.

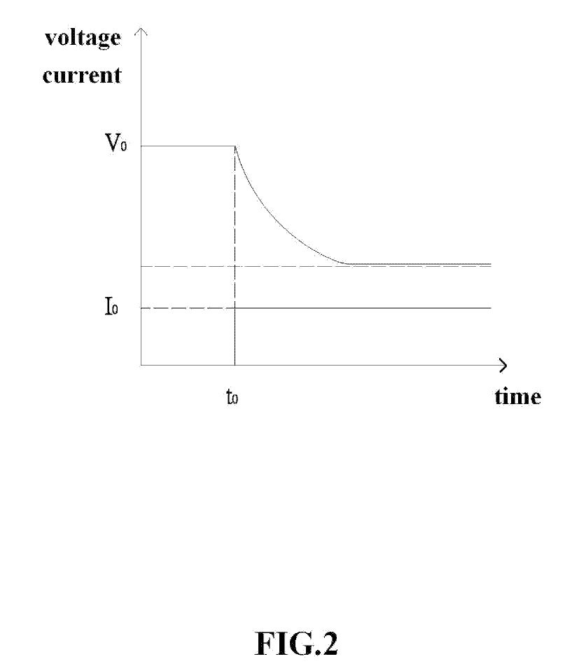

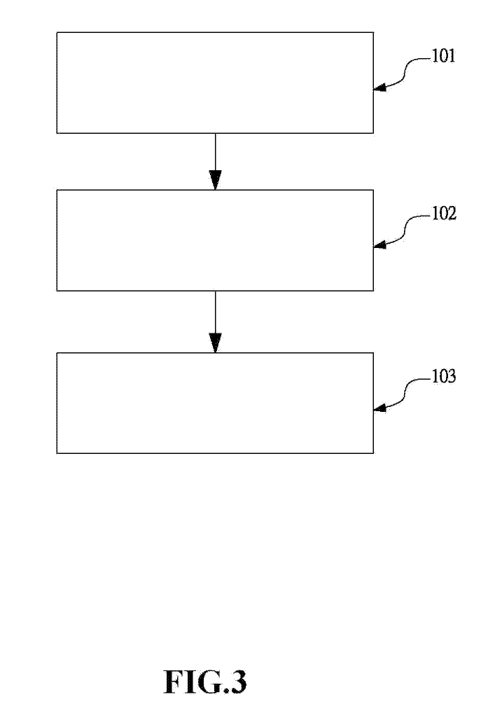

FIG. 2 is a diagram showing the time-voltage curve of the fuel cell in an open circuit. FIG. 3 is a flowchart illustrating the operation of the feedback fuel cell device of this invention. As shown in FIG. 2, the fuel cell of this invention reads the correlation between voltage and temperature when the fuel cell is in an open-circuit state. When the membrane electrode assembly of the fuel cell is in an open circuit state at a specific temperature, the voltage will be hold at V₀ at the time t₀; when the membrane electrode assembly of the fuel cell outputs a current I₀ to a load, the voltage of the membrane electrode assembly in the fuel cell starts to decrease slowly. Therefore, the logic processor of this invention utilizes the open-circuit voltage of the fuel cell membrane electrode assembly corresponding to a specific temperature, and detects the open-circuit voltage of fuel cell membrane electrode assembly so as to obtain the system temperature. As shown in FIG. 1 and FIG. 3, according to the above-mentioned feedback fuel cell device of this invention, the embodiment of the operation process includes: step 101, the load selection mechanism control device of the logic processor 3 controlling the load switching mechanism 22 in the circuit mechanism 2, performing the power transfer selection device so as to set the second membrane electrode assembly to be in an open-circuit state, and feedbacking the open-circuit voltage value of the second membrane electrode assembly measured by the open-circuit voltage detection device of the load switching mechanism 22; step 102, the logic processor 3 performing the temperature determination means based on the open-circuit voltage value of the second membrane electrode assembly 12 fed back by the load switching mechanism 22 and obtaining the temperature value corresponding thereto; step 103, the logic processor 3 performing the power transfer selection device by controlling the load switching mechanism 22 in the circuit mechanism 2 so as to select the second membrane electrode assembly 12 to be in the state of transferring power to the power integration mechanism 21.

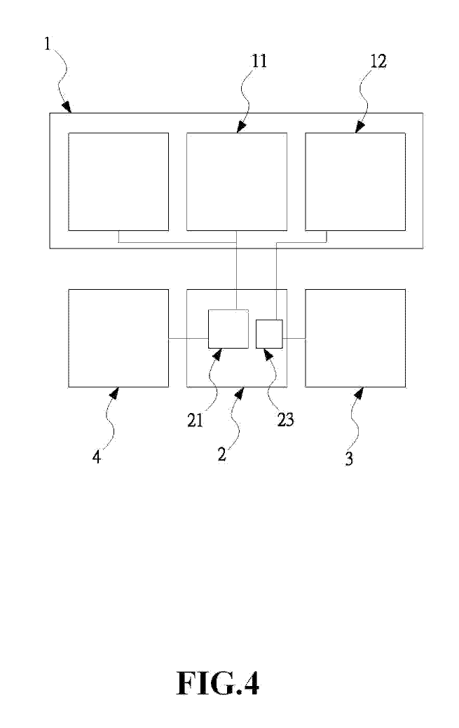

FIG. 4 is a diagram schematically illustrating the components of the feedback fuel cell device in accordance with a further preferred embodiment of this invention. Referring to FIG. 4 and according to the above-mentioned feedback fuel cell device of this invention, the load switching mechanism 22 of the circuit mechanism 2 (shown in FIG. 1) can be directly replaced by the open-circuit voltage detection device 23. Therefore, the electric power output from the first membrane electrode assembly 11 in the fuel cell 1 can be regulated through the power integration mechanism 21 in the circuit mechanism 2 so as to be fed to the load 4 at a specific voltage, current or power; whereas the electric power output from the second membrane electrode assembly 12 in the fuel cell 1 can be transferred to the open-circuit voltage detection device 23 and the temperature determination means will be performed by the logic processor 3 so as to obtain the temperature corresponding to the open-circuit voltage of the second membrane electrode assembly. In a preferred embodiment, the algorithm and the control mechanism of the logic processor can be simplified. For example, the open-circuit voltage detection device 23 can detect the open-circuit voltage of the second membrane electrode assembly 12 continuously or detect the open-circuit voltage of the second membrane electrode assembly 12 periodically by using a timer or a counter, so that the logic processor 3 may not need to have the means to detect the timing of the open-circuit voltage of the second membrane electrode assembly. The logic processor 3 only needs to utilize the reference table or the function-based correspondence between the open-circuit voltage and the temperature, and then performs the temperature determination means through the logic processor 3 by performing data comparison or calculation.

The first membrane electrode assembly 11 and the second membrane electrode assembly 12 in the above-mentioned fuel cell 1 can be constituted through membrane electrode assemblies with different specifications, where the main concept thereof is to select a membrane electrode assembly with a lower-power consumption on the second membrane electrode assembly 12 so as to minimize the fuel consumed thereby.

While the invention has been described in terms of what is presently considered to be the most practical and preferred embodiment, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A feedback fuel cell device, comprising:
a fuel cell;
a circuit mechanism; and
a logic processor;
wherein the fuel cell is electrically connected to the circuit mechanism which comprises a circuit including a power integration mechanism and a means for detecting an open-circuit voltage, wherein the power integration mechanism is electrically connected to a first membrane electrode assembly and provides a power output, and the means for detecting the open-circuit voltage is electrically connected to a second membrane electrode assembly; and
the logic processor is electrically connected to the circuit mechanism and contains a temperature determination means, which determines a temperature value corresponding to the open-circuit voltage of the second membrane electrode assembly through the means for detecting the open-circuit voltage.

2. The feedback fuel cell device of claim 1, wherein the circuit mechanism further comprises a means for power transfer selection for selecting the second membrane electrode assembly to be electrically connected to the means for detecting the open-circuit voltage and to transfer power to the power integration mechanism at any one state thereof, and the logic processor further comprises a load selecting mechanism control device controlling the means for power transfer selection and selecting the second membrane electrode assembly to be electrically connected to the means for detecting the open-circuit voltage and to transfer power to the power integration mechanism at any one state thereof.

3. The feedback fuel cell device of claim 2, wherein the fuel cell, the circuit mechanism and the logic processor are operative such that:
the load selection mechanism control device in the logic processor controls the means for power transfer selection to select the second membrane electrode assembly to be in an open-circuit state, and to feed the open circuit voltage value of the second membrane electrode assembly back to the logic processor through the means for detecting the open-circuit voltage;
the logic processor performs the temperature determination means so as to obtain a temperature value corresponding to the open-circuit voltage of the second membrane electrode assembly; and
the load selection mechanism control device in the logic processor controls the means for power transfer selection to select the second membrane electrodes assembly to transfer power to the power integration mechanism at any one state thereof.

4. The feedback fuel cell device of claim 1, wherein the temperature determination means in the logic processor contains an open-circuit voltage and temperature correspondence which is any means of the function-based calculation process and a reference table.

5. The feedback fuel cell device of claim 1, wherein the fuel cell is a circuit-based multilayered fuel cell.

6. The feedback fuel cell device of claim 1, wherein the fuel cell, the circuit mechanism and the logic processor are electrically connected in such a way that the circuit mechanism and the logic processor are located inside the fuel cell and the circuit mechanism and the logic processor are connected to any means of the fuel cell with an electrical interface.

7. The feedback fuel cell device of claim 1, wherein the power integration mechanism further comprises a means for electric power regulation regulating the power output at one state of a specific voltage, a specific current and a specific power.

8. The feedback fuel cell device of claim 1, wherein the second membrane electrode assembly has a lower power than that of the first membrane electrodes assembly.

9. The feedback fuel cell device of claim 1, wherein the means for detecting the open-circuit voltage is designed to detect the open-circuit voltage of the second membrane electrode assembly continuously.

10. The feedback fuel cell device of claim 1, wherein the means for detecting the open-circuit voltage is controlled by one of a timer and a counter, and detects the open-circuit voltage of the second membrane electrode assembly specifically periodically.
